(19) United States
(12) Patent Application Publication
(10) Pub. No.: US 2022/0301734 A1
(43) Pub. Date: Sep. 22, 2022

(54) ARRANGEMENT AND METHOD FOR DISMANTLING A CONTAINER

(71) Applicant: SIEMPELKAMP NIS INGENIEURGESELLSCHAFT MBH, Alzenau (DE)

(72) Inventors: Stefan DÄTIG, Motten (DE); Andreas LOEB, Nidda (DE)

(73) Assignee: SIEMPELKAMP NIS INGENIEURGESELLSCHAFT MBH, Alzenau (DE)

(21) Appl. No.: 17/633,374

(22) PCT Filed: Jul. 6, 2021
(86) PCT No.: PCT/EP2021/068581

§ 371 Date: Feb. 7, 2022

(30) Foreign Application Priority Data
Jul. 16, 2020 (DE) 10 2020 118 889.7
Oct. 2, 2020 (DE) 10 2020 125 867.4

(51) Int. Cl. G21D 1/00; G21C 19/20; G21F 9/30

(52) U.S. Cl. CPC G21D 1/003; G21C 19/20; G21F 9/30

(57) ABSTRACT

The invention relates to an arrangement for dismantling a container (10) which comprises a circumferential wall (20) and an opening surrounded by said wall and which has a screening cover (14) situated above the opening, and to a dismantling tool for cutting segments (42, 44, 46, 53, 56) out of the circumferential wall. The dismantling takes place in such a way that regions of the circumferential wall which have a hollow cylindrical geometry are successively cut into segments and these segments are then removed. After a segmented region having the hollow cylindrical ring geometry has been removed, an end edge of the remaining circumferential wall is available. The screening cover has a lowering device for successively lowering the screening cover onto a particular available end edge.

The invention relates to an arrangement for dismantling a container, in particular of a nuclear plant, preferably a reactor pressure vessel, which comprises a circumferential wall and an opening surrounded by said wall and which has a screening cover situated above the opening, and to a dismantling tool for cutting segments out of the circumferential wall, wherein the dismantling takes place in such a way that regions of the circumferential wall which have a hollow cylindrical ring geometry are successively cut into segments and these segments are then removed, wherein, after a segmented region having the hollow cylindrical ring geometry has been removed, an end edge of the remaining circumferential wall is available.

The invention also relates to a method for dismantling a container, in particular of a nuclear plant, preferably a reactor pressure vessel, which comprises a circumferential wall and an opening surrounded by said wall and which has a screening cover situated above the opening, and to a dismantling tool for cutting segments out of the circumferential wall, wherein the dismantling takes place in such a way that regions of the circumferential wall which have a hollow cylindrical ring geometry are successively cut into segments and these segments are then removed, wherein, after a segmented region having the hollow cylindrical ring geometry has been removed, an end edge of the remaining circumferential wall is available.

In practice, a corresponding arrangement or related method is employed for decommissioning reactor pressure vessels.

When decommissioning nuclear plants, significant effort is required in particular to dismantle and to remove containers, such as reactor pressure vessels etc. Due to the high levels of radioactivity it must be ensured that the spread of contamination from the inside of the container to be dismantled into surrounding areas is avoided and the environment is screened against the radioactive radiation from the inside of the reactor pressure vessel.

Corresponding containers are usually located inside a pit which is enclosed at the top end in order to allow for air conditioning. A vacuum is established to be able to contain leaking contamination.

As corresponding containers are extremely heavy, it is often difficult to remove them as a unit. Due to the high weight of the container, this also requires that the enclosure be removed to be able to use the lifting tools available in the nuclear plant.

If these disadvantages are to be avoided, a lifting tool is located within the enclosure which can be used to lift parts, i.e. segments, of the dismantled container to be then transferred to another processing station.

The disadvantage of this procedure is that during removal of segments, the screening cover and plate must be kept away from the lifting tool available in the enclosure so that in principle multiple lifting tools are required to remove the segments and at the same time hold the screening cover.

It is the object of the present invention to further develop an arrangement and method of the above mentioned type such that dismantling of a container can be done using constructively simple measures.

According to the arrangement, the object is essentially met in that the screening cover comprises a lowering device for successively lowering the screening cover onto a particular available end edge.

An autonomous system is provided which can be used to align the screening cover with the container without the requirement of a separate lifting tool. Rather, the lowering device integrated with the screening cover is used which can be supported on end edges of the container to the required extent to thus be able to lower the screening cover by the desired amount.

To this end, it is provided in particular that the lowering device comprises at least two supports, preferably three supports offset by 120° with respect to another, which can support the screening cover.

The supports should be end sections of a cross-member which is adjustable with respect to the screening cover at least by means of an adjustment and lifting mechanism, such as a cylinder, spindle, hoist.

The adjustment mechanism with the supports forms the lowering device and are part of it.

To allow for easy dismantling, in an inventive development, the invention provides that a disc element, rotatable with respect to the screening cover and having the geometry of an annular ring, from which the dismantling tool extends is situated at the outside of the screening cover. In particular and also in accordance with an inventive development, it is provided that the disc element, to be referred to as an annular disc, comprises a cutout extension of which in the circumferential direction is greater than the extension of a segment in the circumferential direction.

The radial extension of the cutout should be at least equal or at least approximately equal to the extension of the disc element outside the screening cover.

The screening cover has a circular disc geometry with the disc element radially protruding over its circumferential edge.

In particular, the diameter of the screening cover is smaller than the internal diameter of the container. Nevertheless, only a small clearance is given between the inside of the container and the environment in which the container is located, namely merely a gap between the cutout of the annular disc and the edge of the container or its circumferential wall; as otherwise the space between the screening cover and the container will be covered by the disc element, to be referred to as an annular disc, from which the dismantling tool extends.

It is provided in particular that a carrier for the dismantling tool extends along the inner boundary of the cutout.

Due to the extension of the cutout being greater than the extension of a segment and a segment being cut depending on the extension of the cutout, the circumferential wall can be easily cut, with the dismantling tool being adjustable in the X, Y, Z direction so that axial and radial as well as circumferential cuts confining the segments can be performed to the necessary extent.

A segment is also lifted through the cutout.

The dismantling tool can be a mechanically or thermally operating dismantling tool. As examples, an oxy-fuel cutting tool, a plasma cutting tool, a machining tool can be mentioned.

By rotating the annular disc from which the dismantling extends it can be aligned with desired regions of the circumferential wall of the container and thus perform the required cuts.

It is provided in particular that the disc element is supported with respect to the screening cover by a rotatable bearing.

The invention is also characterized by a method for dismantling a container of a nuclear plant, in particular a reactor pressure vessel, which comprises a circumferential wall and an opening surrounded by said wall and which has a screening cover situated above the opening, and a dismantling tool for cutting segments out of the circumferential wall, wherein the dismantling takes place in such a way that regions of the circumferential wall which have a hollow cylindrical ring geometry are successively cut into segments and these segments are then removed, wherein, after a segmented region having the hollow cylindrical ring geometry has been removed, an end edge of the remaining circumferential wall is available, comprising the following method steps:
cutting segments with the screening cover situated on the opening of a first region having a hollow cylinder ring geometry such that vertical or longitudinal separating cuts extending in the longitudinal direction of the container and, with the exception for at least two segments forming support segments, horizontal or bottom separating cuts extending at the bottom are formed between segments,
removing the segments confined by vertical or longitudinal and horizontal and bottom separating cuts with the support of the screening cover on the at least two remaining support segments being maintained,
supporting the screening cover on the end edge of the circumferential wall formed by removal of the segments by means of the lowering device extending from the screening cover,
forming horizontal or bottom separating cuts in the remaining at least two support segments,
removing the support segments, and
lowering the screening cover onto the end edge by means of the lowering device.

It is provided in particular that, in order to form the segments, initially vertical or longitudinal separating cuts and/or horizontal or bottom separating cuts are partially performed and subsequently remaining regions between the segments and the circumferential wall are cut.

Preferably, the remaining regions should be provided in corner regions of the segments to be cut.

In order to remove the segments, it is merely necessary to move the segments radially with respect to the container by an amount corresponding to the contact area between the lowering device and the edge of the container. It is then possible to lift the segments along the longitudinal axis of the container. As a result, only a small space is required between the container and the screen surrounding it to remove the segments.

To remove a segment, the cutout of the annular disc is aligned with the segment in such a way that the segment can be lifted through the cutout.

Further details, advantages and features of the invention will be apparent not only from the claims, the features to be inferred therefrom—alone and/or in combination—, but also from the following description of a preferred exemplary embodiment that can be inferred from the drawing.

The figures show:

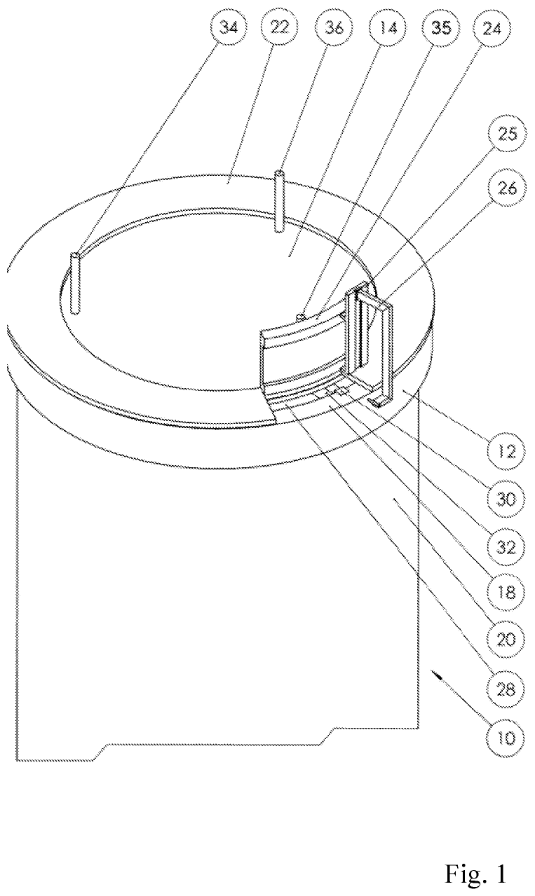

FIG. 1 a detail of a container as a concept drawing,

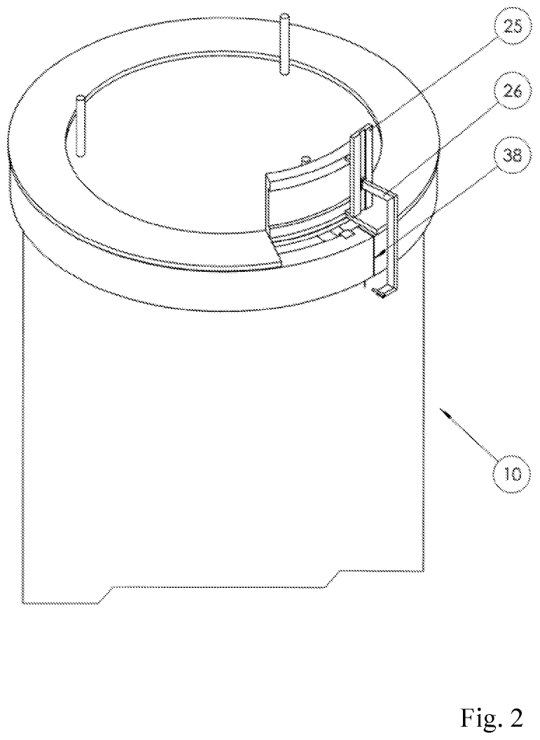

FIG. 2 the container according to FIG. 1 after performing a longitudinal separating cut,

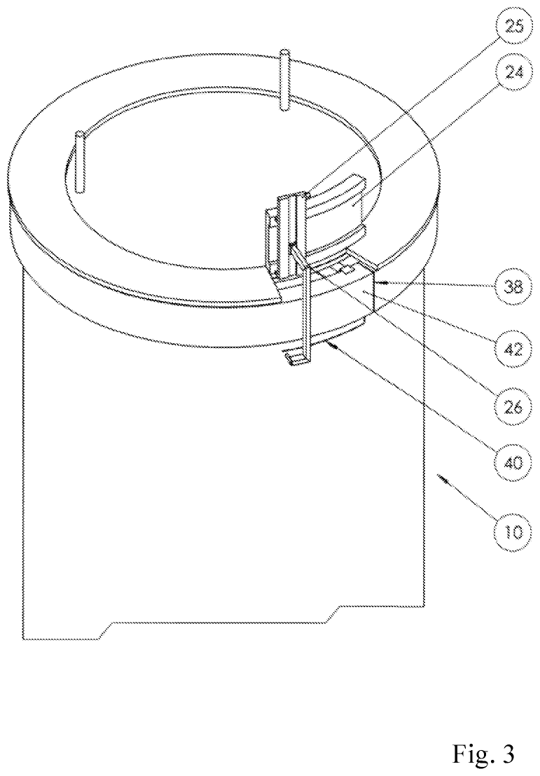

FIG. 3 the container according to FIG. 2 after performing a bottom separating cut,

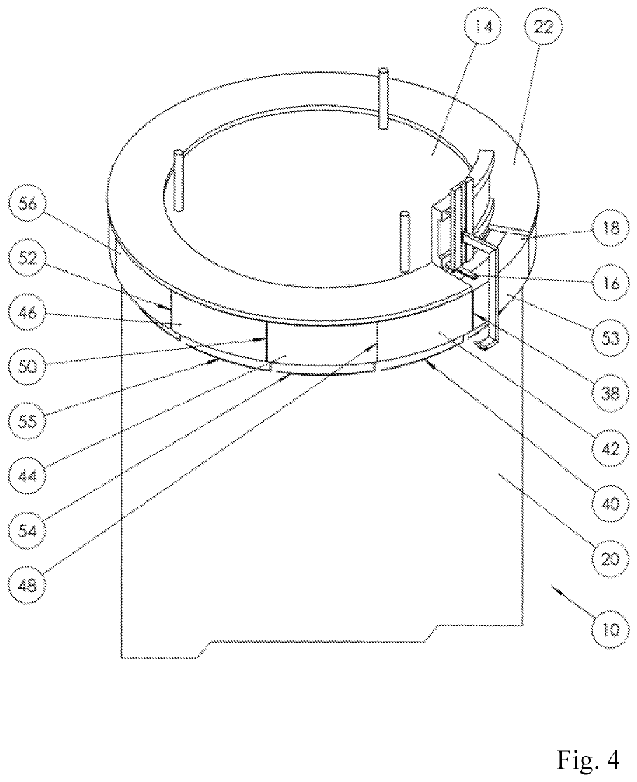

FIG. 4 the container according to FIGS. 1 to 3 after performing a plurality of longitudinal and bottom separating cuts,

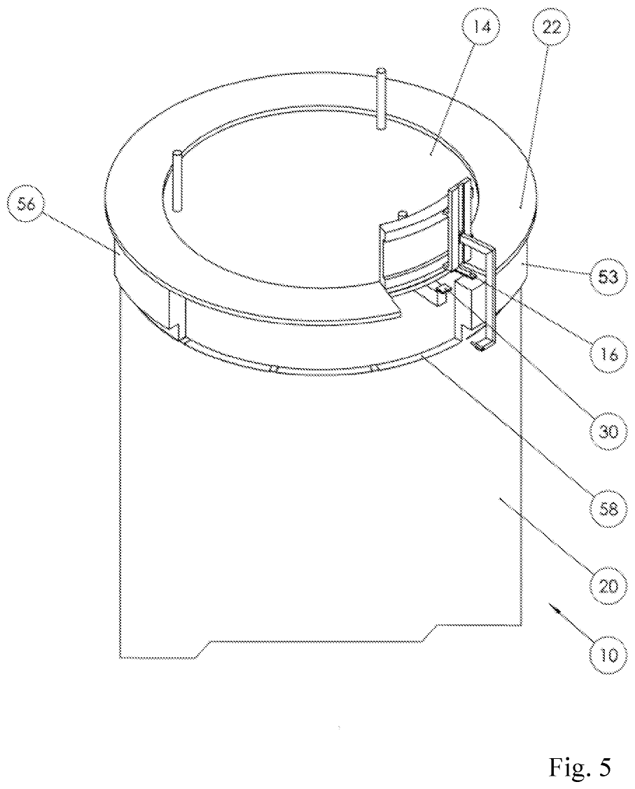

FIG. 5 the container according to FIGS. 1 to 4 after removing segments with remaining support segments,

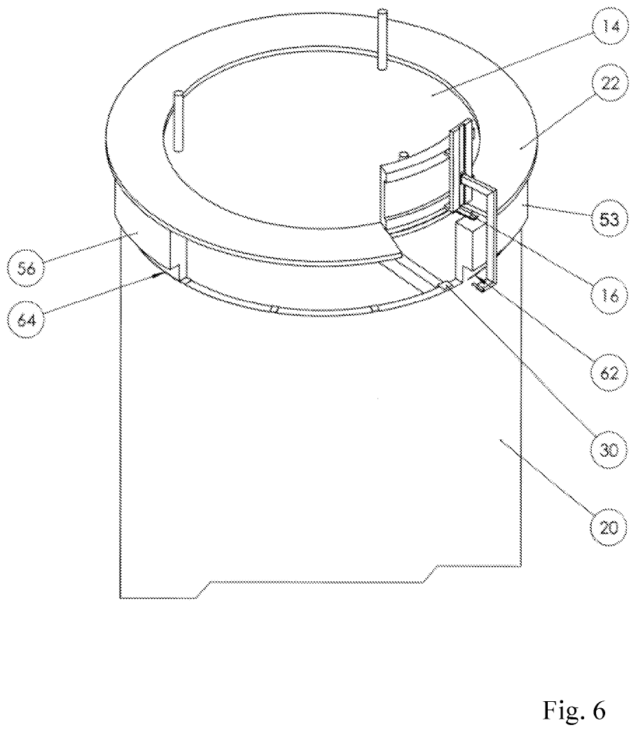

FIG. 6 the container according to FIGS. 1 to 5 with lowered lowering device,

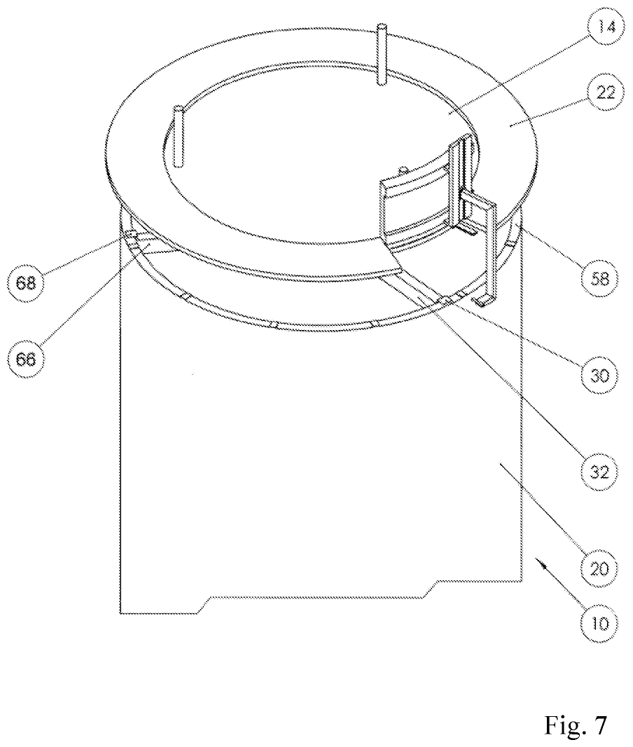

FIG. 7 the container according to FIGS. 1 to 6 after removing support segments, and

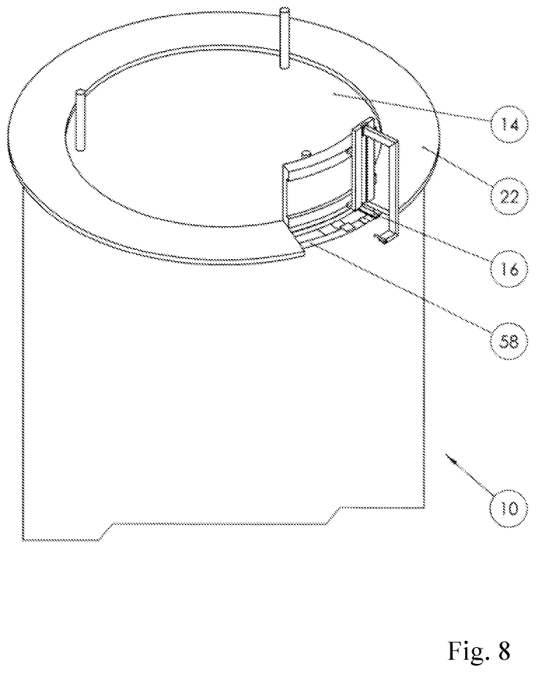

FIG. 8 the container according to FIGS. 1 to 7 with the screening plate lowered onto a container edge.

With reference to the figures, the teaching according to the invention for dismantling a container 10, which in particular is a reactor pressure vessel employed in a nuclear plant, will be explained. Corresponding containers are usually located in a pit screened by a screening plate at the opening side which may optionally be situated directly on the top-end opening of the container having a cylinder shape.

However, the invention is not limited to reactor pressure vessels.

The pit itself is air-enclosed, whereby a vacuum is created in order to avoid a spread of contamination in the reactor building. For example, a packaging station, may also be provided within the air enclosure.

Moreover, a lifting tool, such as a crane, is available within the air enclosure to be able to lift segments cut out of the container so that the existing lifting tools outside the enclosure itself do not need to be used, as otherwise the enclosure would have to be opened.

The invention is generally based on the related state of the art. However, the segmenting of the container 10 is performed in such a way that an autonomous system for covering the container 10 is available regardless of the successive dismantling and thus separate lifting tools are not required. At the same time, easy removal of the segments by means of a lifting tool in particular situated inside the air enclosure is to be enabled, even with limited available space.

FIG. 1 shows a detail of the container 10 as a concept drawing with a flange-type edge 12 extending at the opening side and surrounding an opening which is covered by a screening cover 14 which is a screening plate in a circular shape and which has a circumferential geometry that should correspond to the internal geometry of the container 10 in the opening region.

As can be seen in particular from FIGS. 4 to 8, the screening plate 14 is supported on the edge 18 of the container 10 through strip-shaped ridges 16 extending from said plate.

The diameter of the screening plate 14 is smaller than the internal diameter of the container 10. Regardless, a sufficient screening is realized by the gap between the inside container wall 21 and the screening plate 14 being covered by an annular disc 22 from which a tool carrier 24 for a dismantling tool 26 extends. The annular disc 22 is rotatably secured on the screening plate 14.

As can be seen from the graphic representation, the width of the annular disc 22 is selected such that it can extend externally substantially flush with the circumferential surface of the edge 12, at the same time peripherally overlaps the screening plate 14 with the exception of a cutout 28, in the area of which the tool carrier 24 for the dismantling tool 26 is located.

Thus, only a small gap between the circumferential wall 20 of the container 10 and the inside of the container 10 exists, which, however, does not result in the possibility of a contamination spread.

Moreover, supports 30 which are cranked sections of beams 32 forming a cross-member can be seen in FIG. 1. In the exemplary embodiment, three beams 32 are provided which are connected to each other, wherein the connection between them may be intersected by the longitudinal axis of the container 10. The individual beams 32 are connected to a drive—in the exemplary embodiment, through cylinders—the outer housings 34, 35, 36 of which are indicated in principle.

Three beams 32 with three supports 30—corresponding to three cylinders—are provided offset by a total of 120°, which can be used to successively lower and place the screening plate 14 and thus the annular disc 22 with the dismantling tool 26 on edges of the container wall 20 formed by the removal of segments, as will be explained below.

Consequently, a lowering device is provided which extends from the screening plate 14 and thus provides an autonomous system for covering the container inside according to the progress of the dismantling of the container 10.

The dismantling tool 26 may be a mechanically or thermally operating tool, such as an oxy-fuel cutting tool, a plasma cutting tool or a machining tool, such as, for example, a saw, to name dismantling tools as an example only. According to the graphic representation, the dismantling tool 26 is adjustable in the axial, radial and circumferential direction to perform separating cuts to the desired extent. Accordingly, on the one hand, the tool 26 is adjustable along the tool carrier 24. On the other hand, a mount 25 extends from the tool carrier 24 to allow for axial adjustment of the dismantling tool 26, as can be seen from the figures in a self-explanatory manner.

If the lowering device, i.e. the beams 32, with the supports 30 is adjustable in the longitudinal direction of the container 10 by means of cylinders, then other drives, such as a spindle or pulley, are also possible.

FIG. 1 depicts the state before the start of segmenting. The dismantling tool 26 is in an initial position, in which a vertical cut is to be implemented starting from the top edge 18 upon activation of the dismantling tool 26, as can be seen from FIG. 2. An axial (vertical) or longitudinal separating cut 38 can be seen. It can also be seen that the dismantling tool 26 has been adjusted in the longitudinal direction of the container 10—in the figures downwardly—in the mount 25.

In FIG. 3, after the axial or longitudinal separating cut 38 has been performed, a bottom or horizontal separating cut 40 has been performed in the circumferential direction, by adjusting the dismantling tool 26 in the tool carrier 24 in a clockwise direction in the graphic representation, with its position in the mount 25 remaining unchanged. The guide path of the support 24 has a bend which corresponds to that of the container 10.

After the bottom and horizontal cut 40 have been performed, a second axial separating cut extending in the direction of the edge 18 is performed to produce a segment 42. Accordingly, a plurality of segments is formed, some of which are indicated by the reference numerals 42, 44, 46, as depicted in FIG. 4.

The corresponding segments 42, 44, 46 are confined by both longitudinal or axial separating cuts and bottom or horizontal separating cuts, which are indicated by the reference numerals 38, 48, 50, 52 for the axial separating cuts and by the reference numerals 40, 54, 55 for the horizontal or bottom separating cuts.

In the exemplary embodiment, additional segments 53, 56, which may have the same dimensions as the segments 42, 44, 46, extend at a distance of 120°, in which a bottom or horizontal separating cut has initially not or not fully been implemented so that these segments 53, 56 continue to be securely connected to the circumferential wall 20 of the container 10.

Regardless of that, when implementing both the axial and the bottom separating cuts, the separating cuts should be performed in such a way that a connection among each other and to the circumferential wall 20 is maintained in parts so that there is no risk that the segments can be moved when performing the separating cuts.

The segments 42, 44, 46, 53, 56 shown in FIG. 4 together with other segments in the same plane form collectively a hollow cylinder ring. In order to remove said ring, the segments 42, 44, 46 having partially axial and horizontal separating cuts 38, 48, 50, 52 and 40, 54, 55, respectively are initially entirely separated from the container wall 20 and the adjacent segments 53, 44 and 46, 42 and 44, 56, respectively and then removed by means of a lifting tool. To this end, the cutout 28 of the annular disc 22 is aligned with the segment to be removed to then perform the separating cut for the segment and to lift the segment vertically, unless radial adjustment is required initially, namely with respect to the segments above which the supports 30 (FIG. 1) or the ridges 16 (FIG. 4) extend.

The screening plate 14 with the tool carrier 24 remains on the segments 53, 56 that have not been entirely cut out, to be referred to as support segments, so that the additional segments 42, 44, 46 can be easily removed. This situation is depicted in FIG. 5.

After the cut-out segments 42, 44, 46 have been removed—corresponding segments are also present in the area of the container 10 that is not visible—the lowering device comprising the supports 30 is activated in such a way that the supports 30 are lowered and supported on the edge 58 produced by removal of the cut-out segments 42, 44, 46 in the circumferential wall 20 of the container 10. Correspondingly lowered supports 30 can be seen in FIG. 6.

By lifting the screening plate 14 and thus bringing the ridge-shaped supports 16 out of contact with the support segments 53, 56 the support segments 53, 56 are released and can thus be removed. This can be seen in FIG. 7. The beams 32, 66 with the supports 30, 68 which are supported on the edge 58 of the circumferential wall 20 of the container 10 are visible.

If the screening plate 14 with the annular disc 22 is supported on the edge 58, then the annular disc 22 is adjusted with respect to the cutout 28 in such a way that the support segments 53, 56 are separated from the circumferential wall 20 at the bottom, i.e. a horizontal cut 62, 64 is performed.

The screening plate 14 with the annular disc 22 designed to be rotatable with respect to said plate is then lowered by means of the lowering device so that the ridge-shaped supports 16 can be placed on the edge 58 and thus the previously explained procedure can be performed again so that hollow cylinder rings of the container 10 formed by segments can be successively removed and the container thus be dismantled.

1. An arrangement for dismantling a container (10), in particular of a nuclear plant, preferably a reactor pressure vessel, which comprises a circumferential wall (20) and an opening surrounded by said wall and which has a screening cover (14) situated above the opening, and a dismantling tool (26) for cutting segments (42, 44, 46, 53, 56) out of the circumferential wall, wherein the dismantling takes place in such a way that regions of the circumferential wall which have a hollow cylindrical ring geometry are successively cut into segments and these segments are then removed, wherein, after a segmented region having the hollow cylindrical ring geometry has been removed, an end edge (58) of the remaining circumferential wall is available,
characterized in that
the screening cover (14) comprises a lowering device (30, 32, 66, 68) for successively lowering the screening cover onto a particular available end edge (58).

2. The arrangement according to claim 1,
characterized in that
the lowering device (30, 32, 66, 68) comprises at least two supports (30, 68), preferably three supports offset by 120° with respect to another, which can support the screening cover (14).

3. The arrangement according to claim 1,
characterized in that
the supports (30, 68) are end sections of a cross-member (32, 66) which is adjustable with respect to the screening cover (14) at least by means of an adjustment mechanism, such as a cylinder, spindle, hoist.

4. The arrangement according to claim 1,
characterized in that
a disc element (22), rotatable with respect to the screening cover and having the geometry of an annular ring or an annular ring segment, from which the dismantling tool (26) extends, is situated at the outside of the screening cover (14).

5. The arrangement according to claim 1,
characterized in that
the screening cover (14) has a circular disc geometry with the disc element (22) radially protruding over its circumferential edge.

6. The arrangement according to claim 1,
characterized in that
the disc element (22) comprises a cutout (28) the extension of which in the circumferential direction is greater than the extension of a segment (42, 44, 46, 53, 56) in the circumferential direction.

7. The arrangement according to claim 1,
characterized in that
the radial extension of the cutout (28) is at least equal or at least approximately equal to the radial extension of the disc element (22) outside the screening cover (14).

8. The arrangement according to claim 1,
characterized in that
a tool carrier (24) for the dismantling tool (26) is situated along the inner boundary of the cutout (28).

9. The arrangement according to claim 1,
characterized in that
the dismantling tool (26) is a mechanically or thermally operating dismantling tool, such as an oxy-fuel cutting tool, a plasma cutting tool, a machining or grinding tool.

10. The arrangement according to claim 1,
characterized in that
the screening cover (14) having a disc geometry has a diameter which is smaller than the diameter of the opening of the container (10).

11. The arrangement according to claim 1,
characterized in that
the disc element (22) is supported with respect to the screening cover (14), for example, by roller blocks guided in a track of the disc element or another suitable support.

12. A method for dismantling a container (10), in particular of a nuclear plant, preferably a reactor pressure vessel, which comprises a circumferential wall (20) and an opening surrounded by said wall and which has a screening cover (14) situated above the opening, and a dismantling tool (26) for cutting segments (42, 44, 46, 53, 56) out of the circumferential wall, wherein the dismantling takes place in such a way that regions of the circumferential wall which have a hollow cylindrical ring geometry are successively cut into segments and these segments are then removed, wherein, after a segmented region having the hollow cylindrical ring geometry has been removed, an end edge (58) of the remaining circumferential wall is available, comprising the following method steps:
cutting segments (42, 44, 46, 53, 56) with the screening cover (14) situated on the opening of a first region having a hollow cylinder ring geometry such that axial or longitudinal separating cuts (38, 48, 50, 52) extending in the longitudinal direction of the container (10) and, with the exception for at least two segments (53, 56) forming support segments, horizontal or bottom separating cuts (40, 54, 55) extending at the bottom are formed between segments,
removing the segments (42, 44, 46, 53, 56) confined by axial or longitudinal and horizontal and bottom separating cuts with the support of the screening cover (14) on the at least two remaining support segments being maintained,
supporting the screening cover on the end edge (58) of the circumferential wall (20) formed by removal of the segments by means of the lowering device (30, 32, 66, 68) extending from the screening cover,
forming horizontal or bottom separating cuts in the support segments,
removing the support segments, and
lowering the screening cover onto the end edge by means of the lowering device.

13. The method according to claim 12,
characterized in that
in order to form the segments (42, 44, 46, 53, 56), initially axial or longitudinal separating cuts (38, 48, 50, 52) and/or horizontal or bottom separating cuts (40, 54, 55) are partially performed and subsequently remaining regions between the segments and the circumferential wall (20) are cut.

14. The method according to claim 13,
characterized in that
the remaining regions are provided in corner regions of the segments (42, 44, 46, 53, 56) to be cut.

15. The method according to claim 12,
characterized in that
supports (30, 68) of the lowering device contact the end edge (58) of the circumferential wall (20) over a radial extension which is smaller than the width of the end edge.

16. The method according to claim 12,
characterized in that
in order to remove the segments (42, 44, 46, 53, 56), said segments are initially radially adjusted according to the contacting radial extension by means of a lifting device and then lifted along the longitudinal axis of the container (10).

17. The method according to claim 16, characterized in that the segments (42, 44, 46, 53, 56) are lifted through a cutout (28) of an annular disc element (22) from which the dismantling tool (26) extends, wherein the annular disc element is rotatably disposed with respect to the screening cover (14) and protrudes radially beyond said cover.
